(19) United States
(12) Patent Application Publication
(10) Pub. No.: US 2026/0215880 A1
(43) Pub. Date: Jul. 30, 2026

(54) DETACHABLE ROTATING JOINT FOR A MEDICAL AND DENTAL DEVICE

(71) Applicant: The Dental Enterprise LLC dba MZK DENTAL PRODUCTS, Bloomfield Township, MI (US)

(72) Inventor: Nizar N. Mansour, Bloomfield Township, MI (US)

(21) Appl. No.: 19/040,573

(22) Filed: Jan. 29, 2025

(51) Int. Cl. A61C 3/14

(52) U.S. Cl. CPC A61C 3/14

(57) ABSTRACT

A medical or dental device including a first arm having a male attachment feature and a second arm having a female attachment feature that interacts with the male attachment feature. The first arm and the second arm can be detached from each other when the medical or dental device is in a position and are attached to each other when the medical or dental device are in one of a plurality of other positions.

### BACKGROUND

In the dental industry, dental extraction forceps, dental pliers, and other dental tools routinely have a non-detachable rotating joint. Microorganisms could become trapped in an inaccessible part of the joint.

### SUMMARY

A medical or dental device including a first arm having a male attachment feature and a second arm having a female attachment feature that interacts with the male attachment feature. The first arm and the second arm can be detached from each other when the medical or dental device is in a position and are attached to each other when the medical or dental device are in one of a plurality of other positions.

A medical or dental device including a first arm having a male attachment feature and a second arm having a female attachment feature that interacts with the male attachment feature. The first arm and the second arm can be detached from each other when the medical or dental device is in a position and are attached to each other when the medical or dental device are in one of a plurality of other positions. The male attachment features includes a male component, a cylindrical structure that supports the male component, and a raised circular surface that surrounds the cylindrical structure. The female attachment feature including a circular track, a bore, and a counter-bore. The bore includes a portion shaped to correlate to the shape of the male component and a circular portion. The portion and the circular portion are coaxial. The counter-bore is cylindrical in shape and accommodates a largest dimension of the male component. The circular portion is received in the bore, and the circular track is received in the raised circular surface.

### BRIEF DESCRIPTION OF THE DRAWINGS

FIG. 1 shows a medical or dental device;

FIG. 2 shows a perspective view of a male components of a triangular detachable rotating joint of the medical or dental device;

FIG. 3 shows a top view of the male component of the triangular detachable rotating joint;

FIG. 4 shows a cross-sectional view of the male component of the triangular detachable rotating joint;

FIG. 5 shows a perspective view of a female component of the triangular detachable rotating joint;

FIG. 6 shows a top view of the female component of the triangular detachable rotating joint;

FIG. 7 shows a cross-sectional view of the female component of the triangular detachable rotating joint;

FIG. 8 shows a perspective view of the male component of a square detachable rotating joint;

FIG. 9 shows a top view of the male component of the square detachable rotating joint;

FIG. 10 shows a cross-sectional view of the male component of the square detachable rotating joint;

FIG. 11 shows a perspective view the female component of the square detachable rotating joint;

FIG. 12 shows a top view of the female component of the square detachable joint;

FIG. 13 shows a cross-sectional view of the female component of the square detachable rotating joint;

FIG. 14 shows a perspective view of the male component of a rectangular detachable rotating joint; and

FIG. 15 shows a perspective view of the female component of the rectangular detachable rotating joint.

### DETAILED DESCRIPTION

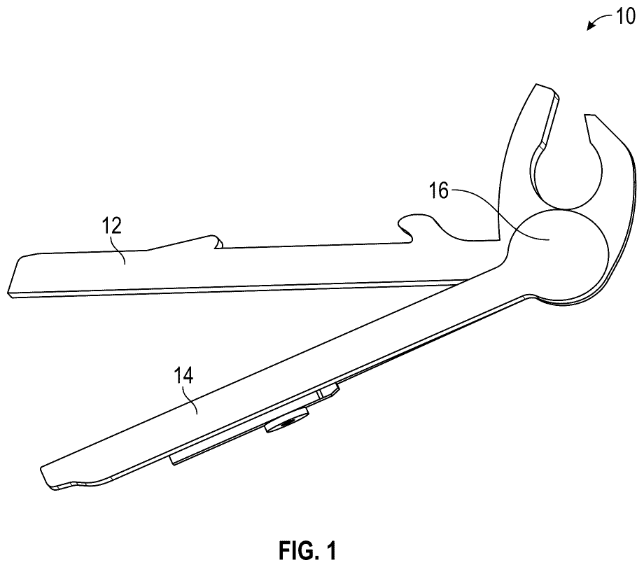

FIG. 1 illustrates a medical or dental device 10, such as a pair of medical or dental forceps. The medical or dental device 10 includes a first arm 12 having a male attachment feature 18 and a second arm 14 having a female attachment feature 20. The first arm 12 and the second arm 14 are attached at a detachable rotating joint 16.

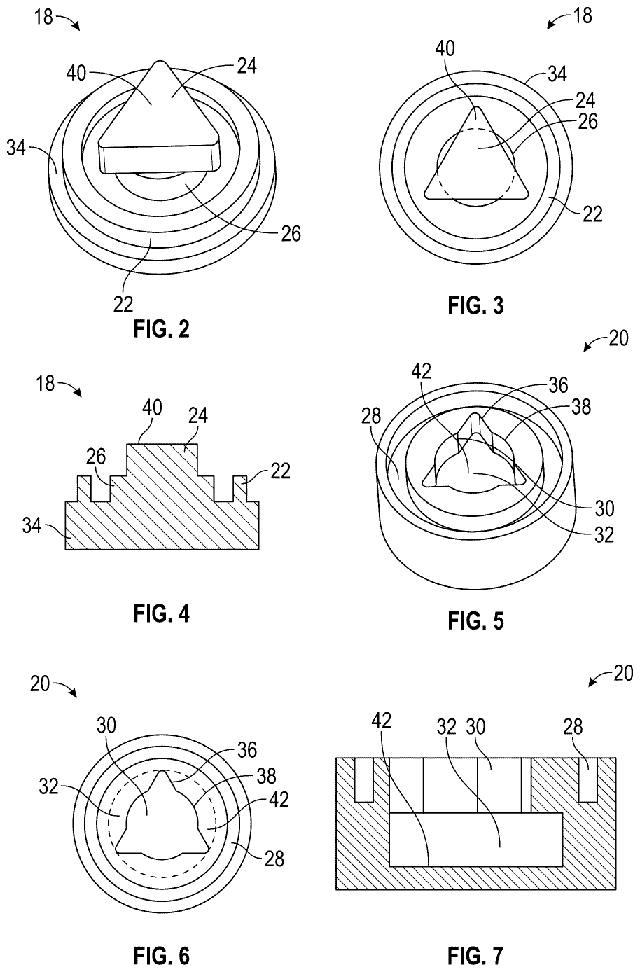

FIGS. 2, 3, and 4 show the male attachment feature 20 of the detachable rotating joint 16 of the first medical or dental device 10. The first medical or dental device 10 includes a body 34 having a male component 24, a cylindrical structure 26 supporting the male component 24, and a raised circular surface 22 that surrounds the cylindrical structure 26.

The male component 24 has a non-circular shape. The shape of the male component 24 can be triangular, square, rectangular, or any shape. In one example, the male component 24 is triangular. The cylindrical structure 26 has a cylindrical shape.

FIGS. 5, 6, and 7 show the female attachment feature 20 that interacts with the male attachment feature 18 of the detachable rotating joint 16. The female attachment feature 20 includes a bore 30, a counter-bore 32, and a circular track 28 that surrounds the bore 30.

The circular track 28 is shaped to receive and interface with the raised circular surface 22 to help stabilize the joint 16. The shape of the raised circular surface 22 correlates to the shape of the circular track 28. Although the male attachment feature 18 has been described to include the raised circular surface 22 and the female attachment feature 20 has been described to include the circular track 28, the male attachment feature 18 could include the circular track 28 and the female attachment feature 20 could include the raised circular surface 22.

The bore 30 includes a triangular portion 36 coaxial with a circular portion 38. The triangular portion 36 is larger than the circular portion 38 such that the 3 points of the triangular portion 36 are located outside the circle. The bore 30 is sized and shaped to receive the male component 24 and the cylindrical structure 26. The triangular portion 36 of the bore 30 is sized and shaped to allow the male component 24 to pass through the triangular portion 36 and enter the counter-bore 32, and the circular portion 38 of the bore 30 is sized and shaped to receive the cylindrical structure 26 and allow rotation freely inside the bore 30.

As shown in FIG. 2d, the counter-bore 32 is cylindrical in shape and correlates to the size and shape of the male component 24 to allow rotation of the male component 24 within the counter-bore 32. The counterbore 32 has a diameter that accommodates the largest dimension of the male component 24.

The cylindrical structure 26 helps stabilize the detachable rotating joint 16 during rotation of the first arm 12 and the second arm 14 relative to each other and keeps the male component 24 and the bore 30 centered, allowing the male component 24 to freely rotate within the counter-bore 32.

When assembling the medical or dental device 10, the male component 24 is received in and passes through the bore 30 to be received in the counter-bore 32. The cylindrical structure 26 is received in the circular portion 38 of the bore 30. An upper surface 40 of the male component 24 contacts or is adjacent to a floor 42 of the counter-bore 32. At this point, the detachable rotating joint 16 is not yet engaged, and the detachable rotating joint 16 can be separated by pulling the male component 24 and the bore 30 apart as the male component 24 and the bore 30 are aligned. The first arm 12 and the second arm 14 can be detached when the medical or dental device 10 is in a position.

Movement of the first arm 12 and the second arm 14 to a plurality of other positions misaligns the male component 24 and the bore 30 relative to each other, preventing the removal of the male component 24 from the bore 30 and attaching the first arm 12 and the second arm 14 of the medical or dental device 10. During rotation, the male component 24 moves within the counter-bore 32, the cylindrical structure 26 moves within the bore 30, and the raised circular surface 22 moves within the circular track 28. The medical or dental device 10 can then be employed on a patient.

Depending on the shape of the male component 24 and the bore 30, a certain degree of rotation can occur before the male component. 24 and the bore 30 realign, allowing the first arm 12 and the second arm 14 of the detachable rotating joint 16 to disengage.

The first arm 12 and the second arm 14 can rotate 120° relative to each other before the male component 24 and the bore 30 realign, which can allow the first arm 12 and the second arm 14 to disengage from each other in this position. When the first arm 12 and the second arm 14 continue to rotate relative to each other, the male component 24 and the bore 30 are no longer aligned. As the 3 points of the triangle of the male component 24 move within the circumscribed cylinder, the male component 24 is retained in the bore 30 except at the locations 120° spaced apart where the male component 24 and the bore 30 are aligned.

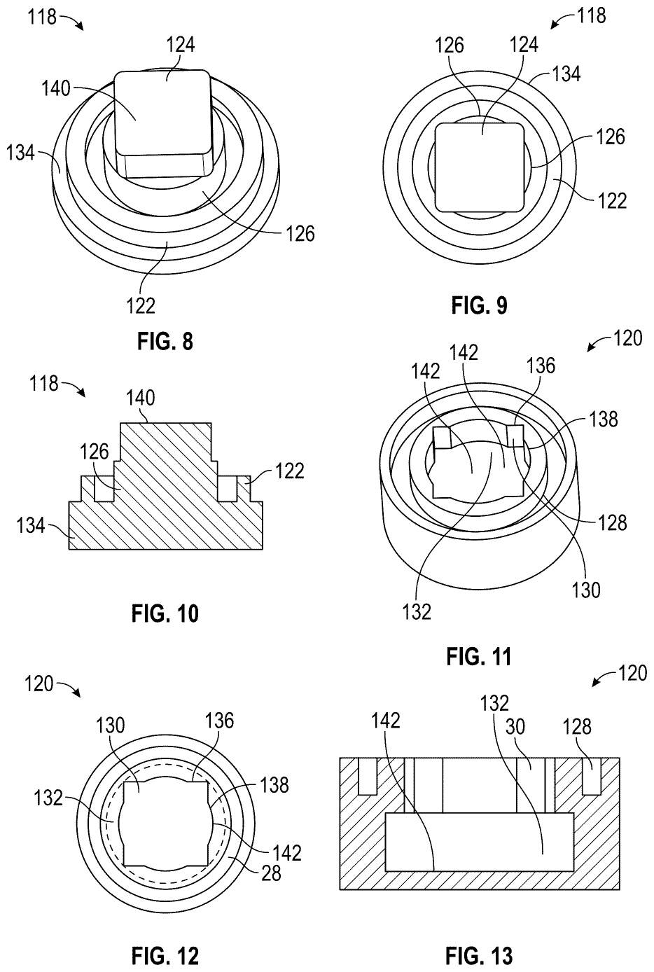

In another example shown in FIGS. 8 to 13, where like features described above include the addition of the number 1 before the reference numerals, the male component 124 is square. The medical or dental device 110 includes features and operates as described above with respect to FIGS. 2 to 7. The first arm 112 and the second arm 14 can rotate 90° relative to each other before the male component 124 and the bore 130 align to allow the first arm 112 and the second arm 114 to disengage at the detachable rotating joint 116. When the first arm 112 and the second arm 114 are rotated relative to each other, the male component 124 and the bore 130 are no longer aligned, and the first arm 112 and the second arm 114 are secured together. As the 4 points of the square of the male component 124 move within the circumscribed cylinder, the male component 124 is retained in the bore 130.

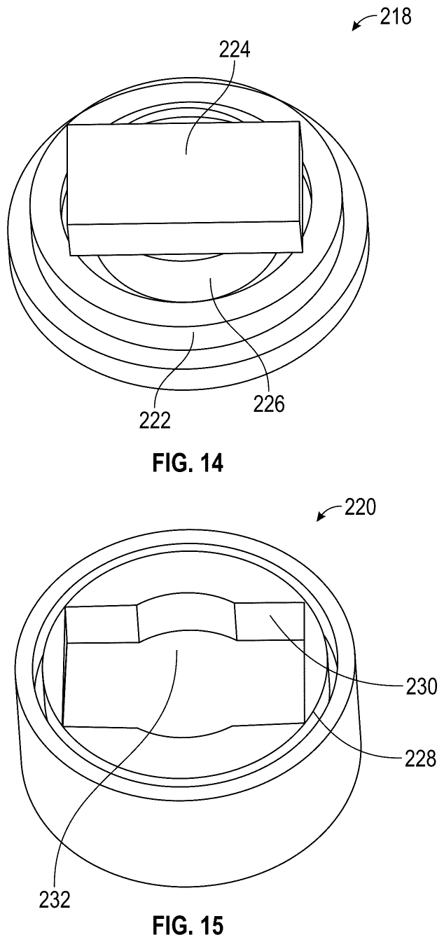

In another example shown in FIGS. 14 to 15, where like features described above include the addition of the number 2 before the reference numerals the male component 224 is rectangular. The medical or dental device 210 includes features and operates as described above with respect to FIGS. 2 to 7. The first arm 212 and the second arm 214 can rotate 180° relative to each other before the male component 224 and the bore 230 align to allow the first arm 212 and the second arm 14 to disengage at the detachable rotating joint 216. When the first arm 212 and the second arm 214 are rotated relative to each other, the male component 224 and the bore 230 are no longer aligned, and the first arm 212 and the second arm 214 are secured together. As the 4 points of the rectangle of the male component 224 move within the circumscribed cylinder, the male component 224 is retained in the bore 230.

When the medical or dental device 10 needs to be cleaned, the first arm 12 from the second arm 14 are pivoted about the detachable rotating joint 16 to align the male component 24 and the bore 30 so that the first arm 12 and the second arm 14 can be detached from each other. This allows for easy cleaning and sterilization of the medical or dental device 10.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason, the following claims should be studied to determine the true scope and content of this invention.

What is claimed is:

1. A medical or dental device comprising:
a first arm having a male attachment feature; and
a second arm having a female attachment feature that interacts with the male attachment feature, wherein the first arm and the second arm can be detached from each other when the medical or dental device is in a position and are attached to each other when the medical or dental device are in one of a plurality of other positions.

2. The device as recited in claim 1 wherein the male attachment features includes a male component, a cylindrical structure that supports the male component, and a raised circular surface that surrounds the cylindrical structure.

3. The device as recited in claim 1 wherein the female attachment feature includes a circular track, a bore, and a counter-bore.

4. The device as recited in claim 2 wherein the male component has a non-circular shape.

5. The device as recited in claim 4 wherein the male component is triangular.

6. The device as recited in claim 4 wherein the male component is square.

7. The device as recited in claim 4 wherein the male component is rectangular.

8. The device as recited in claim 1 wherein:
the male attachment features includes a male component, a cylindrical structure that supports the male component, and a raised circular surface that surrounds the cylindrical structure, and
the female attachment feature receives and interacts with the male attachment feature, the female attachment feature including a circular track, a bore, and a counter-bore.

9. The device as recited in claim 8 wherein the bore includes a portion shaped to correlate to the shape of the male component and a circular portion, wherein the portion and the circular portion are coaxial.

10. The device as recited in claim 8 wherein the counter-bore is cylindrical in shape and accommodates a largest dimension of the male component.

11. The device as recited in claim 8 wherein the circular portion is received in the bore.

12. The device as recited in claim 8 wherein the male component has a position where the male component aligns with the bore to allow removal of the male component from the bore and another position where the male component does not align with the bore to prevent removal of the male component from the bore.

13. The device as recited in claim 8 wherein the circular track is received in the raised circular surface.

14. A medical or dental device comprising:
a first arm having a male attachment feature; and
a second arm having a female attachment feature that interacts with the male attachment feature, wherein the first arm and the second arm can be detached from each other when the medical or dental device is in a position and are attached to each other when the medical or dental device are in one of a plurality of other positions,
wherein the male attachment features includes a male component, a cylindrical structure that supports the male component, and a raised circular surface that surrounds the cylindrical structure, and
wherein the female attachment feature including a circular track, a bore, and a counter-bore, wherein the bore includes a portion shaped to correlate to the shape of the male component and a circular portion, the portion and the circular portion are coaxial, and the counter-bore is cylindrical in shape and accommodates a largest dimension of the male component, the circular portion is received in the bore, and the circular track is received in the raised circular surface.

15. The device as recited in claim 14 wherein the male component has a non-circular shape.

16. The device as recited in claim 15 wherein the male component is triangular.

17. The device as recited in claim 15 wherein the male component is square.

18. The device as recited in claim 15 wherein the male component is rectangular.
